(19) United States
(12) Patent Application Publication
(10) Pub. No.: US 2026/0010979 A1
(43) Pub. Date: Jan. 8, 2026

(54) METHOD FOR THE ADVANCE OPTICAL CAPTURE OF A FIELD AREA TO BE WORKED

(71) Applicant: Deere & Company, Moline, IL (US)

(72) Inventors: Stefan Brocke, Mannheim (DE); Danesh Rohinton Gandhi, Pune (IN)

(21) Appl. No.: 19/240,830

(22) Filed: Jun. 17, 2025

(30) Foreign Application Priority Data
Jul. 5, 2024 (EP) 24186967.6

(51) Int. Cl. G06T 5/50; A01B 79/00; G05D 1/225; G05D 107/20; G05D 109/25; G06T 7/73

(52) U.S. Cl. CPC G06T 5/50; A01B 79/005; G05D 1/225; G06T 7/73; G05D 2107/21; G05D 2109/254; G06T 2207/10032; G06T 2207/20221; G06T 2207/30204; G06T 2207/30244; G06T 2207/30252

(57) ABSTRACT

The disclosure relates to advance optical capture of a field area. An agricultural work vehicle is equipped with a first imaging sensor unit. A remote-controllable drone is equipped with a second imaging sensor unit. A first field area portion lying ahead in the direction of travel is captured by the first imaging sensor unit. A second field area portion lying ahead in the direction of travel is captured by the second imaging sensor unit. A relative position and/or orientation of the two imaging sensor units is ascertained by a position-determining unit. Image data provided by the first and second imaging sensor units is transmitted to a control unit. Taking into account the ascertained relative position and/or orientation of the two imaging sensor units, the control unit merges the image data to generate a complete view of the two captured field area portions, represented visually via a graphic user interface.

### CROSS-REFERENCE TO RELATED APPLICATIONS

This application claims priority to European Patent Application No. 24186967.6, filed Jul. 5, 2024, which is hereby incorporated by reference.

### TECHNICAL FIELD

The present disclosure relates generally to a method for advanced optical capture of a field area to be worked.

### BACKGROUND

In the case of agricultural work vehicles, such as agricultural tractors, field choppers or harvesting machines, the view of a field area which is located in the direction of travel and is to be worked by means of the agricultural work vehicle is restricted to a greater or lesser extent by add-on or accessory devices, for example a pusher plate, a mower or a harvesting attachment, but also by the vehicle contours themselves. This is remedied, amongst other things, by cameras which are mounted at a suitable point on the agricultural work vehicle or on the add-on or accessory device and which therefore expand the field of vision in the direction of travel of the agricultural work vehicle by generating a corresponding camera image on a separate display.

### SUMMARY

According to an aspect of the present disclosure, a method for advance optical capture of a field area to be worked, comprising: capturing a first field area portion lying ahead in the direction of travel by a first imaging sensor unit equipped on an agricultural work vehicle, capturing a second field area portion lying ahead in the direction of travel by a second imaging sensor unit equipped on a remote-controllable drone, ascertaining a relative position or orientation of the first and second imaging sensor units by a position-determining unit, transmitting image data provided by the first and second imaging sensor units to a control unit, and merging the image data to generate a complete view of the first and second captured field area portions which can be represented visually via a graphic user interface, by taking into account the ascertained relative position or orientation of the first and second imaging sensor units.

According to an aspect of the present disclosure, a system for advance optical capture of a field area to be worked, comprising an agricultural work vehicle equipped with a first imaging sensor unit configured to capture a first field area portion lying ahead in the direction of travel, a remote-controllable drone equipped with a second imaging sensor unit configured to capture a second field area portion lying ahead in the direction of travel, and a position-determining unit configured to ascertain relative position or orientation of the first and second imaging sensor units. The image data provided by the first and second imaging sensor unit is transmitted to a control unit configured to merges the image data to generate a complete view of the first and second captured field area portions which can be represented visually via a graphic user interface by taking into account the ascertained relative position or orientation of the first and second imaging sensor units.

Other features and aspects will become apparent by consideration of the detailed description, claims, and accompanying drawings.

### BRIEF DESCRIPTION OF THE DRAWINGS

The method according to the disclosure will be explained in more detail hereinafter on the basis of the appended drawings, in which:

FIG. 1 shows an exemplary embodiment, illustrated as a flow chart, of the method according to the disclosure for the advance optical capture of a field area to be worked.

FIG. 2 shows an exemplary embodiment, illustrated schematically, of a device for carrying out the method according to the disclosure illustrated in FIG. 1.

Like reference numerals are used to indicate like elements throughout the several figures.

### DETAILED DESCRIPTION

The object of the present disclosure is to specify a method of the type mentioned at the outset, which is further improved in terms of the benefit to the driver.

This object is achieved by a method for the advance optical capture of a field area to be worked, which has the features of one or more embodiments disclosed herein”.

In the method for the advance optical capture of a field area to be worked, it is provided that an agricultural work vehicle is equipped with a first imaging sensor unit and a remote-controllable drone is equipped with a second imaging sensor unit, a first field area portion lying ahead in the direction of travel being captured by the first imaging sensor unit and a second field area portion lying ahead in the direction of travel being captured by the second imaging sensor unit, and a relative position and/or orientation of the two imaging sensor units being ascertained by means of a position-determining unit, image data provided by the first and second imaging sensor unit being transmitted to a control unit, which, taking into account the ascertained relative position and/or orientation of the two imaging sensor units, merges the image data to generate a complete view of the two captured field area portions which can be represented visually via a graphic user interface.

This procedure enables a field area lying ahead in the direction of travel to be presented on the graphic user interface in its entirety and therefore in a manner which is particularly clear for the driver. To this end, the respective image data are overlapped with each other with the aim of providing a gap-free or complementary reproduction of the two field area portions by means of the control unit or a graphic computer associated with the graphic user interface, for which the relative position and/or orientation of the two imaging sensor units, and therefore their “viewing direction” with respect to each other, is likewise included.

The graphic user interface may be a conventional touch-sensitive display;

however, the use of a head-up display is also conceivable, which enables the complete view of the field area lying ahead in the direction of travel to be presented visually by showing it in a cab windshield of the agricultural work vehicle and therefore directly in the field of view of the driver.

The first imaging sensor unit is arranged fixed to the vehicle in such a way that it permits the capture of the first field area portion beyond the outer contours of the agricultural work vehicle, or an add-on or accessory device mounted thereon, toward the front (or rear). The second imaging sensor unit, together with the position-determining unit, is, however, associated with the drone and is therefore mobile or flexible in terms of its spatial position relative the agricultural work vehicle, which enables full capture of the second field area portion which is at least partially hidden from the view of the driver. The flight of the drone is, in particular, coordinated or remote-controlled by the control unit via a wireless connection. The imaging sensor units are typically mono or stereo cameras.

The specified direction of travel relates, in the present case, to an intentional or actual forward travel of the agricultural work vehicle, but it may essentially also relate to a reverse travel.

The agricultural work vehicle may be, amongst other things, an agricultural tractor, a field chopper or a harvesting machine; the add-on or accessory device which can be or is mounted thereon may be a pusher plate, a mower, a harvesting attachment or the like.

Advantageous developments of the method according to the disclosure are revealed in one or more embodiments disclosed herein”.

To ascertain the relative position and/or orientation of the two imaging sensor units, the use of the second image-capturing sensor unit, which is present in any case, is preferred. To this end, it is provided that a spatial position of an optical marking applied to the agricultural work vehicle relative to the second imaging sensor unit is derived by the position-determining unit from the image data of the second imaging sensor unit, the derived spatial position being transformed onto the spatial position of the first imaging sensor unit by the position-determining unit to ascertain the relative position and/or orientation of the two imaging sensor units. The spatial position of the optical marking applied to a suitable point of the agricultural work vehicle, i.e. a point located in the field of view of the second imaging sensor unit, relative to the first imaging sensor unit can be derived here by image analysis or triangulation of its sensor-captured image in conjunction with the current altitude of the drone. The current altitude of the drone may be ascertained by means of an IMU (inertial measurement unit) comprised therein.

The image data of the second imaging sensor unit, together with information relating to the ascertained relative position and/or orientation of the two imaging sensor units, which is provided by the position-determining unit, may then be transmitted wirelessly to the control unit for further evaluation via a data interface communicating with the position-determining unit. The data interface may likewise serve to control the drone remotely.

The optical marking may be a QR code, for example. The QR code likewise enables the assignment of features which can be read out by means of the second imaging sensor unit. These features may serve for vehicle identification, for example in the event that one and the same drone is used to carry out the method according to the disclosure for multiple (different) agricultural work vehicles and corresponding adaptation of a spatial setpoint flying position to be assumed relative to the relevant agricultural work vehicle is therefore needed.

In the simplest case, the control unit may be part of an already present control-device architecture of the agricultural work vehicle.

It may also be provided that the control unit communicates with a central data server, the image data provided by the first and second imaging sensor unit, together with the information relating to the ascertained relative position and/or orientation of the two imaging sensor units, which is provided by the position-determining unit, while simultaneously locating the current cartographic position of the agricultural work vehicle, being transmitted wirelessly to the central data server via a further data interface and, after the merging thereof to produce a visual representation of the generated complete view, from there to the graphic user interface or the graphic computer in the agricultural work vehicle via the control unit. The ascertainment of the current cartographic position of the agricultural work vehicle takes place using a GPS navigation system.

The use of a central data server enables relatively high computing powers to be provided and (within the context of an expanded or upgradable service) enables the image data to be merged to be combined in a simplified manner with additional information from further data sources, for example relating to weather influences, phenotypic features of a cultivated area to be worked and the like, which can be presented on the graphic user interface. To analyze phenotypic features, in particular within the context of a rating system for plant status assessment using artificial intelligence, the sensitivity of the imaging sensor units may extend beyond the visible wavelength range into the near infrared range. The visual representation of the phenotypic features acquired from the image data on the graphic user interface may be realized in pseudocolor. It is essentially also possible for such additional functions to be realized by the control unit itself, in which case the additional information to be presented on the graphic user interface is made available to the control unit by the central data server via the further data interface in order for it to be included accordingly.

There is furthermore the option of using the information relating to the ascertained relative position and/or orientation of the two imaging sensor units, which is provided by the position-determining unit, to control the flight of the drone, in particular to maintain a predetermined spatial flying position relative to the agricultural work vehicle. To this end, corrective regulating commands are generated on the basis of an established deviation relative to the spatial setpoint flying position.

Furthermore, the different “viewing directions” of the two imaging sensor units enable a three-dimensional surface contour of the field area to be worked, including obstacles located thereon, to be synthesized from the merged image data by the control unit during the generation of the complete view. The progression of the field area to be worked can therefore be assessed particularly reliably by the driver.

Against a similar background, a sensor-captured horizontal position of the agricultural work vehicle may be additionally or alternatively taken into account by the control unit during the generation of the complete view. The sensor-capture of the horizontal position is revealed in information relating to a current roll angle, pitch angle and/or yaw angle of the agricultural work vehicle, which is provided by an inertial measurement unit or IMU fixed to the vehicle.

A visual representation, at least in outline form, of the agricultural work vehicle and of an add-on or accessory device which is possibly mounted thereon may be also realized by the control unit during the generation of the complete view. The image data of the second imaging sensor unit here enables the provision of an overhead, bird's eye view from the viewpoint of the drone.

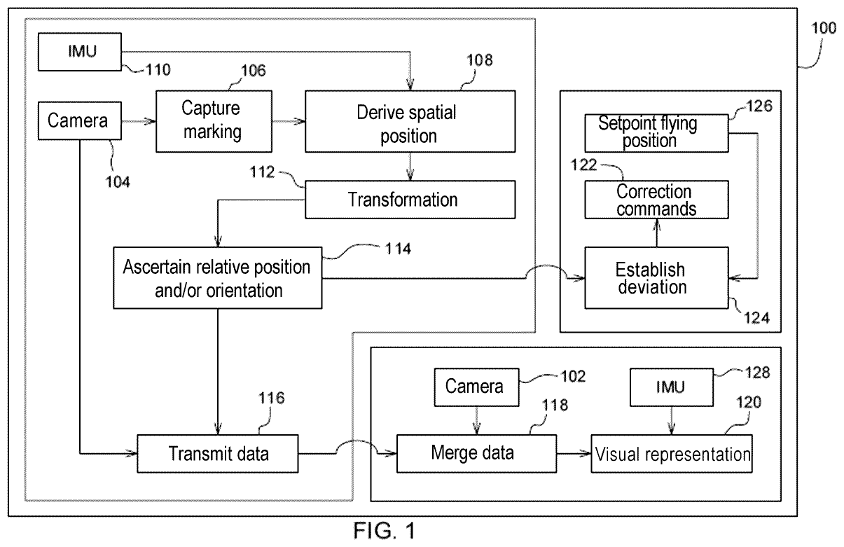

FIG. 1 shows an exemplary embodiment, illustrated as a flow chart, of the method according to the disclosure for the advance optical capture of a field area to be worked.

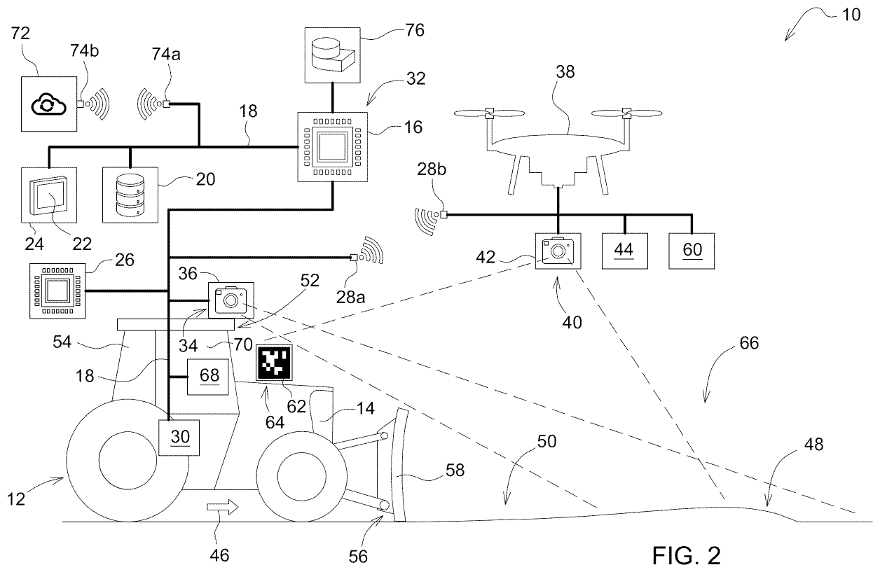

The device 10 according to FIG. 2, which is provided to carry out the method, shall be discussed first. The device 10, which is associated with an agricultural work vehicle 12—an agricultural tractor 14 in the present case-comprises a microprocessor-controlled control unit 16, which is in data-exchanging communication with an internal memory unit 20, a graphic user interface 24 designed as a touch-sensitive display 22, with a graphic computer 26, a data interface 28a, 28b and an inertial measurement unit or IMU 30 fixed to the vehicle, via a BUS system 18. The control unit 16 here is part of a control device architecture 32 (not illustrated in more detail) of the agricultural tractor 14.

Furthermore, the agricultural tractor 14 is equipped with a first imaging sensor unit 34 in the form of a first mono or stereo camera 36 and a remote-controllable drone 38 with a second imaging sensor unit 40 in the form of a second mono or stereo camera 42 and a position-determining unit 44. As can be seen in FIG. 2, a first field area portion 48 lying ahead in the direction of travel 46 is captured by the first imaging sensor unit 34 and a second field area portion 50 lying ahead in the direction of travel 46 is captured by the second imaging sensor unit 40.

The first imaging sensor unit 34 is arranged, fixed to the vehicle, in an elevated position in a front roof area 52 of a driver's cab 54 of the agricultural tractor 14 in such a way that it permits the capture of the first field area portion 48 beyond the outer contours of the agricultural tractor 14, or an add-on or accessory device 56 mounted thereon, toward the front. The add-on or accessory device 56 is, for example, a pusher plate 58. The second imaging sensor unit 40 is, however, associated with the drone 38 and is therefore mobile or flexible in terms of its spatial position relative the agricultural tractor 14, which enables full capture of the second field area portion 50 which is at least partially hidden from the view of the driver. The flight of the drone 38 is coordinated or remote-controlled by the control unit 16 via the wireless connection produced via the data interface 28a, 28b. To ascertain the current altitude of the drone 38, this likewise comprises an inertial measurement unit or IMU 60.

An optical marking 62 is applied to the agricultural tractor 14 at a suitable point, i.e. a point located in the field of view of the second imaging sensor unit 40. The optical marking 62 is, for example, a QR code 64, which is applied to an upper side of a hood of the agricultural tractor 14 as a sticker.

For the sake of completeness, it should be noted that the specified direction of travel 46 in the present case relates to an intentional or actual forward travel of the agricultural tractor 14, although it may essentially also refer to a reverse travel.

Moreover, the illustration of the agricultural work vehicle 12 as an agricultural tractor 14 is merely exemplary in nature. In addition to an agricultural tractor 14, this may also be any other agricultural work vehicle 12; for example a field chopper or a harvesting machine, in which the add-on or accessory device 56 which can be or is mounted thereon may be a mower, a harvesting attachment or the like instead of a pusher plate 58.

With reference to the flow chart illustrated in FIG. 1, the method, which is carried out by the control unit 16 and stored as corresponding program code in the internal memory unit 20, is started by the operator in a superordinate starting step 100 through the selection of a camera assistance mode via the touch-sensitive display 22 of the graphic user interface 24, whereupon, in a first main step 102 and a second main step 104 respectively, the first imaging sensor unit 34 and the second imaging sensor unit 40 are initiated to capture the field area portion located in their respective field of view 48, 50.

In a third main step 106, the optical marking 62 located in the field of view of the second imaging sensor unit 40 is furthermore captured by this latter in order to derive the spatial position of the optical marking 62 relative to the second imaging sensor unit 40 from the image data of the second imaging sensor unit 40 in a fourth main step 108 through image analysis or triangulation of its sensor-captured image in conjunction with the current altitude of the drone 38. The current altitude of the drone 38 is ascertained in a first auxiliary step 110 by means of the inertial measurement unit 60 comprised therein. Since the optical marking 62 is applied to the agricultural tractor 14 with an offset relative to the first imaging sensor unit 34, the spatial position of the optical marking 62 relative to the second imaging sensor unit 40, which is derived in the fourth main step 108, is firstly transformed onto the spatial position of the first imaging sensor unit 34 by the position-determining unit 44 in a fifth main step 112 in order to ascertain a relative position and/or orientation of the two imaging sensor units 34, 40 on the basis thereof in a sixth main step 114.

In a seventh main step 116, the information relating to the ascertained relative position and/or orientation of the two imaging sensor units 34, 40, which is provided by the position-determining unit 44 in the sixth main step 114, is transmitted wirelessly to the BUS system 18 of the agricultural tractor 14 via the data interface 28a, 28b, together with the image data provided by the second imaging sensor 40, and from the BUS system of the agricultural tractor to the control unit 16, together with the image data provided by the first imaging sensor unit 34 in the first main step 102.

In an eighth main step 118, executed by the control unit 16, these are merged with each other to generate a complete view of the two captured field area portions 48, 50, which can be visually represented via the graphic user interface 24 in a ninth main step 120, taking into account the ascertained relative position and/or orientation of the two imaging sensor units 34, 40.

This procedure enables a field area 66 lying ahead in the direction of travel 46 to be presented on the graphic user interface 24 in its entirety and therefore in a manner which is particularly clear for the driver. To this end, the respective image data are overlapped with each other with the aim of providing a gap-free or complementary reproduction of the two field area portions 48, 50 by means of the control unit 16 or the graphic computer 26, for which the relative position and/or orientation of the two imaging sensor units 34, 30 and therefore their “viewing direction” with respect to each other is included.

In this connection, it should be mentioned that, instead of visually representing the complete view on a conventional display 22, the use of a head-up display 68 is also conceivable, which enables the visual presentation of the complete view of the field area 66 lying ahead in the direction of travel 46 by showing it in a cab windshield 70 of the agricultural tractor 14 and therefore directly in the field of view of the driver (see FIG. 2).

It is additionally provided that the information relating to the ascertained relative position and/or orientation of the two imaging sensor units 34, 40, which is provided by the position-determining unit 44, is used to control the flight of the drone 38, namely to maintain a predetermined spatial flying position relative to the agricultural tractor 14. To this end, in a second auxiliary step 122, corrective regulating commands are generated on the basis of an established deviation relative to the spatial setpoint flying position established in a third auxiliary step 124. The specification of the spatial setpoint flying position takes place here in a fourth auxiliary step 126 and is specific to the relevant agricultural work vehicle 12.

With regard to the manner in which the complete view is presented on the graphic interface 24, various options are possible.

Firstly, the different “viewing directions” of the two imaging sensor units 34, 30 enable a three-dimensional surface contour of the field area 66 to be worked, including obstacles located thereon, to be synthesized from the merged image data by the control unit 16 during the generation of the complete view. The progression of the field area 66 to be worked can therefore be assessed particularly reliably by the driver.

Against a similar background, a sensor-captured horizontal position of the agricultural tractor 14 is additionally or alternatively taken into account by the control unit 16 during the generation of the complete view. The sensor-capture of the horizontal position is revealed in information relating to a current roll angle, pitch angle and/or yaw angle of the agricultural tractor 14, which is provided by the inertial measurement unit 30 fixed to the vehicle in a fifth auxiliary step 128.

A visual representation, at least in outline form, of the agricultural tractor 14, and of the add-on or accessory device 56 mounted thereon, may also be realized by the control unit 16 during the generation of the complete view. The image data of the second imaging sensor unit 40 here enable the provision of an overhead, bird's eye view from the viewpoint of the drone 38.

Features which can be read out by means of the second imaging sensor unit 40 are likewise assigned to the QR code 64. These features may serve for vehicle identification, specifically in the event that one and the same drone 38 is used to carry out the method according to the disclosure for multiple (different) agricultural work vehicles 12 and corresponding adaptation to a spatial setpoint flying position to be assumed relative to the relevant agricultural work vehicle 12 is therefore needed.

According to a modification of the device 10, which is indicated by dashed lines in FIG. 2, it is also provided that the control unit 16 communicates with a central data server 72, the image data provided by the first and second imaging sensor unit 34, 40, together with the information relating to the relative position and/or orientation of the two imaging sensor units 34, 40, which is provided by the position-determining unit 44, while simultaneously locating the current cartographic position of the agricultural tractor 14, being transmitted wirelessly to the central data server 72 via a further data interface 74a, 74b and, after the merging thereof to produce a visual representation of the generated complete view, from there to the graphic user interface 24 or the graphic computer 26 in the agricultural tractor 14 via the control unit 16. The ascertainment of the current cartographic position of the agricultural tractor takes place using a GPS navigation system 76.

The use of a central data server 72 enables relatively high computing powers to be provided and (within the context of an expanded or upgradable service) enables the imaged data to be merged to be combined in a simplified manner with additional information from further data sources, for example relating to weather influences, phenotypic features of a cultivated area to be worked and the like, which can be presented on the graphic user interface 24. To analyze phenotypic features, in particular within the context of a rating system for plant status assessment using artificial intelligence, the sensitivity of the imaging sensor units 34, 40 may extend beyond the visible wavelength range into the near infrared range. The visual representation of the phenotypic features acquired from the image data on the graphic user interface 24 may be realized in pseudocolor. The realization of such additional functions is essentially also possible via the control unit 16 itself, in which case the additional information to be presented on the graphic user interface 24 is made available to the control unit 16 by the central data server 72 via the further data interface 74a, 74b in order for it to be included accordingly.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for advanced optical capture of a field area to be worked, comprising:
capturing a first field area portion lying ahead in the direction of travel by a first imaging sensor unit equipped on an agricultural work vehicle,
capturing a second field area portion lying ahead in the direction of travel by a second imaging sensor unit equipped on a remote-controllable drone,
ascertaining a relative position or orientation of the first and second imaging sensor units by a position-determining unit,
transmitting image data provided by the first and second imaging sensor units to a control unit, and
merging the image data to generate a complete view of the first and second captured field area portions which can be represented visually via a graphic user interface, by taking into account the ascertained relative position or orientation of the first and second imaging sensor units.

2. The method of claim 1, wherein a spatial position of an optical marking applied to the agricultural work vehicle relative to the second imaging unit is derived from the image data of the second imaging sensor unit by the position-determining unit, the derived spatial position being transformed onto the spatial position of the first imaging sensor unit by the position-determining unit to ascertain the relative position or orientation of the first and second imaging sensor units.

3. The method of claim 2, wherein the optical marking is a QR code.

4. The method of claim 1, wherein the image data of the second imaging sensor unit, together with information relating to the ascertained relative position or orientation of the first and second imaging sensor units, which is provided by the position-determining unit, is transmitted wirelessly to the control unit via a data interface communicating with the position-determining unit.

5. The method of claim 1, wherein the control unit is part of a control device architecture of the agricultural work vehicle.

6. The method of claim 1, wherein the control unit communicates with a central data server, the image data provided by the first and second imaging sensor unit, together with information relating to the ascertained relative position or orientation of the first and second imaging sensor units, which is provided by the position-determining unit, being transmitted wirelessly to a central data server and, after the merging thereof to produce a visual representation of the generated complete view, from there to the graphic user interface in the agricultural work vehicle via the control unit.

7. The method of claim 1, wherein information relating to the ascertained relative position or orientation of the first and second imaging sensor units, which is provided by the position-determining unit, is used to control the flight of the drone, in particular to maintain a predetermined spatial flying position relative to the agricultural work vehicle.

8. The method of claim 1, wherein a three-dimensional surface contour of the field area to be worked, including obstacles located thereon, is synthesized from the merged image data by the control unit during the generation of the complete view.

9. The method of claim 1, wherein a sensor-captured horizontal position of the agricultural work vehicle is taken into account by the control unit during the generation of the complete view.

10. The method of claim 1, wherein a visual representation, at least in outline form, of the agricultural work vehicle and of an add-on or accessory device which is possibly mounted thereon is realized by the control unit during the generation of the complete view.

11. A system for advanced optical capture of a field area to be worked, comprising:
an agricultural work vehicle equipped with a first imaging sensor unit configured to capture a first field area portion lying ahead in the direction of travel,
a remote-controllable drone equipped with a second imaging sensor unit configured to capture a second field area portion lying ahead in the direction of travel,
a position-determining unit configured to ascertain relative position or orientation of the first and second imaging sensor units,
wherein image data provided by the first and second imaging sensor unit is transmitted to a control unit configured to merges the image data to generate a complete view of the first and second captured field area portions which can be represented visually via a graphic user interface by taking into account the ascertained relative position or orientation of the first and second imaging sensor units.

12. The system of claim 11, wherein a spatial position of an optical marking applied to the agricultural work vehicle relative to the second imaging unit is derived from the image data of the second imaging sensor unit by the position-determining unit, the derived spatial position being transformed onto the spatial position of the first imaging sensor unit by the position-determining unit to ascertain the relative position or orientation of the first and second imaging sensor units.

13. The system of claim 12, wherein the optical marking is a QR code.

14. The system of claim 11, wherein the image data of the second imaging sensor unit, together with information relating to the ascertained relative position or orientation of the first and second imaging sensor units, which is provided by the position-determining unit, is transmitted wirelessly to the control unit via a data interface communicating with the position-determining unit.

15. The system of claim 11, wherein the control unit is part of a control device architecture of the agricultural work vehicle.

16. The system of claim 11, wherein the control unit communicates with a central data server, the image data provided by the first and second imaging sensor unit, together with information relating to the ascertained relative position or orientation of the first and second imaging sensor units, which is provided by the position-determining unit, being transmitted wirelessly to a central data server and, after the merging thereof to produce a visual representation of the generated complete view, from there to the graphic user interface in the agricultural work vehicle via the control unit.

17. The system of claim 11, wherein information relating to the ascertained relative position or orientation of the first and second imaging sensor units, which is provided by the position-determining unit, is used to control the flight of the drone, in particular to maintain a predetermined spatial flying position relative to the agricultural work vehicle.

18. The system of claim 11, wherein a three-dimensional surface contour of the field area to be worked, including obstacles located thereon, is synthesized from the merged image data by the control unit during the generation of the complete view.

19. The system of claim 11, wherein a sensor-captured horizontal position of the agricultural work vehicle is taken into account by the control unit during the generation of the complete view.

20. The system of claim 11, wherein a visual representation, at least in outline form, of the agricultural work vehicle and of an add-on or accessory device which is possibly mounted thereon is realized by the control unit during the generation of the complete view.
